(19) United States
(12) Patent Application Publication
(10) Pub. No.: US 2009/0008955 A1
(43) Pub. Date: Jan. 8, 2009

(54) SYSTEM AND METHOD FOR AUTOMATICALLY DESIGNING AN AUTOMOBILE WRAP

(76) Inventor: Sergio Desoto, Tulsa, OK (US)

Correspondence Address: FELLERS SNIDER BLANKENSHIP;BAILEY & TIPPENS, THE KENNEDY BUILDING, 321 SOUTH BOSTON SUITE 800, TULSA, OK, 74103-3318, US

(21) Appl. No.: 12/167,822

(22) Filed: Jul. 3, 2008

Related U.S. Application Data
(60) Provisional application No. 60/947,783, filed on Jul. 3, 2007.

(51) Int. Cl. B60J 9/00; G09F 21/04

(52) U.S. Cl. 296/1.08; 40/591

(57) ABSTRACT

There is provided herein a system and method for rapidly and accurately creating vehicles wraps for use on cars, trailers, and the like. In a preferred embodiment, a digital photograph of the vehicle is imported into a graphics editing program where the vehicle image is stretched to reflect the actual surface area of the automobile or other vehicle. The graphic image that is to be applied is then dragged over the model of the actual surface area of the vehicle and positioned according to the desires of the designer. Once the graphic design is satisfactorily positioned, the instant invention will take that image and print it on what is preferably two or four mil vinyl film using specialized printers (e.g., an ink jet printer) designed for that purpose. Thereafter, the film containing the graphic image will be applied to the subject vehicle as is conventionally done.

### RELATED CASES

This application claims the benefit of U.S. Provisional Patent Application Ser. No. 60/947,783 filed on Jul. 3, 2007 and incorporates said provisional application by reference into this document as if fully set out at this point.

### FIELD OF THE INVENTION

The present invention relates generally to the field of decorative and/or informative automobile enhancements and, more generally, to the field of automatic creation of vehicle wraps.

### BACKGROUND OF THE INVENTION

Vehicle wraps are a well-known means of decorating and/or placing advertising on vehicles such as vans, cars, trucks, trailers, buses, semi's, RV's, etc. (collectively, “vehicles” hereinafter). In brief, a vehicle wrap is a vinyl, plastic sheet, or other conformable material upon which a graphical image has been printed. The wrap is preferably removably affixed (e.g., via adhesive) to the exterior of a vehicle, thereby giving the impression that the vehicle has been custom painted. Of course, one advantage of a vehicle wrap is that the wrap can be removed, if somewhat laboriously, and the design changed unlike a painted solution.

Although there is a growing demand for this product, designing wraps for vehicles can be very challenging. In more particular, it can prove to be quite challenging to accurately fit a wrap design—which has been printed on a flat surface—to curving and undulating surfaces such are common on many vehicles. Because of the complex three-dimensional shape of a vehicle exterior, designing and printing a graphic on a flat surface for application to the curved surfaces on the vehicle may lead to instances where the graphic after application is not positionable as the designer had intended.

Further, in many cases the dimensions of the automobile estimated from a photograph of that vehicle (i.e., a 2D projection of the photographed car surface), a process that tends to deemphasize the 3D nature of this problem.

Accordingly it should now be recognized, as was recognized by the present inventor, that there exists, and has existed for some time, a very real need for a system and method that would address and solve the above-described problems.

Before proceeding to a description of the present invention, however it should be noted and remembered that the description of the invention which follows, together with the accompanying drawings, should not be construed as limiting the invention to the examples (or preferred embodiments) shown and described. This is so because those skilled in the art to which the invention pertains will be able to devise other forms of the invention within the ambit of the appended claims.

### SUMMARY OF THE INVENTION

There is provided herein a system and method for rapidly and accurately creating vehicles wraps for use on cars, trailers, and the like. In a preferred embodiment, the vehicle is photographed at high resolution. The dimensions of the vehicle are then hand measured, taking into account body lines and moldings. The photograph is then imported into a graphics editing program such as PHOTOSHOP® where the unwrappable parts are separated from the wrappable parts of the vehicle, and the vehicle image is stretched to reflect the actual surface area of the automobile or other vehicle. The graphic image that is to be applied is then dragged over the model of the actual surface area of the vehicle and positioned according to the desires of the designer.

Finally, once the graphic design is satisfactorily positioned, the instant invention will take that image and print it on what is preferably two or four mil vinyl film using specialized printers (e.g., an ink jet printer) designed for that purpose. Thereafter, the film containing the graphic image will be applied to the subject vehicle as is conventionally done.

The foregoing has outlined in broad terms the more important features of the invention disclosed herein, so that the detailed description that follows may be more clearly understood, and so that the contribution of the instant inventors to the art may be better appreciated. The instant invention is not limited in its application to the details of the construction and to the arrangements of the components set forth in the following description or illustrated in the drawings. Rather the invention is capable of other embodiments and of being practiced and carried out in various other ways not specifically enumerated herein. Additionally, the disclosure that follows is intended to apply to all alternatives, modifications and equivalents as may be included within the spirit and the scope of the invention as defined by the appended claims. Further, it should be understood that the phraseology and terminology employed herein are for the purpose of description and should not be regarded as limiting, unless the specification specifically so limits the invention.

### BRIEF DESCRIPTION OF THE DRAWINGS

Other objects and advantages of the invention will become apparent upon reading the following Detailed Description and upon reference to the drawings in which:

FIG. 1 illustrates a an image of a vehicle suitable for use with the instant invention.

FIG. 2 provides additional information regarding the 3D shape of the vehicle.

FIGS. 3A and 3B illustrate a typical measurement scheme for door element 105 that would be suitable for use with the instant invention.

FIGS. 4A and 4B illustrate schematically how the actual surface measurements of FIG. 3 might be used to stretch the image of the door 105 according to the instant invention.

FIG. 5 illustrates how the instant invention might operate when a digital representation of a vehicle wrap pattern is shown on a computer screen together with a stretched version of a car element.

FIG. 6 illustrates how a graphic might be position on the subject door, the image of which has been distorted according to the instant invention.

FIG. 7 illustrates some preferred steps in the instant invention.

FIG. 8 illustrates how a printed wrap might appear according to the instant invention.

FIG. 9 provides a schematic illustration of a vehicle after the instant wrap has been applied.

FIG. 10 illustrates how a vehicle (as opposed to a vehicle element like a door) might be measured for treatment by the instant invention.

FIG. 11 contains a schematic illustration of how the vehicle of FIG. 10 might appear after stretching according to the measurements of FIG. 10.

### DESCRIPTION OF THE PREFERRED EMBODIMENTS

Referring now to the drawings, wherein like reference numerals indicate the same parts throughout the several views, there is provided a system and method for quickly and accurately creating vehicle wraps according to the instant invention.

By way of general background, those of ordinary skill in the art will readily recognize the problem that is solved by the instant invention.

Broadly speaking, the instant invention operates by first obtaining a photograph of the vehicle for which the wrap is being designed. This might be a photo of the actual vehicle or a photo of the same type of vehicle (e.g., a stock photo that can be used with all vehicles of the same make, model, and year). The template photograph will then be distorted to so that its surface area is proportional to the actual surface area of the subject vehicle.

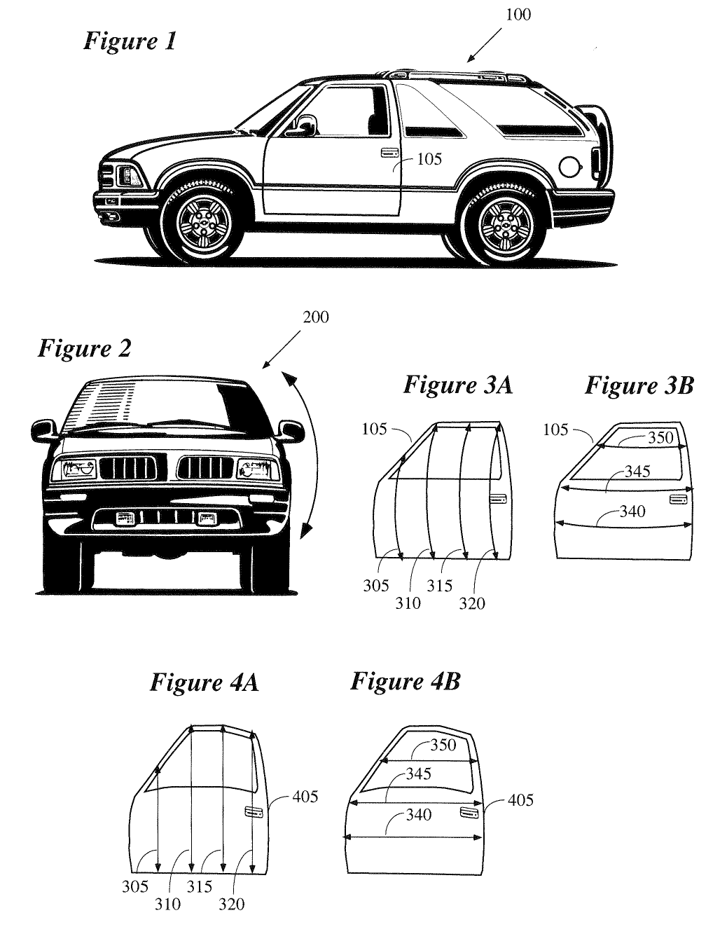

FIG. 1 contains schematic illustration of a photo of a vehicle 100. Of particular interest for purposes of the instant disclosure is the configuration and 3D shape of the door 105 which is to be fitted with a wrap according to the methods of the instant invention. As is made clearer by a front view of FIG. 2, although the door 105 might appear to be flat in the 2D projection of FIG. 1, on most cars the doors are curved and have ridges and other features. As a consequence, if an attempt is made to estimate the actual surface area or surface dimensions of the door 105 by measurements taken on the photo of FIG. 1, such measurements will tend to understate the actual surface area of that item.

FIGS. 3 and 4 further illustrate this point. FIG. 3A illustrates a series of bottom to top measurements 305-320 of the door 105, wherein the measurements are taken along the actual surface of the door 105. The arrows 305-320 that schematically represent these measurements have been drawn to be curved in FIG. 3A to highlight the fact that the actual surface distance will be different (longer) than the vertical top-to-bottom measurement taken at the same point. Similarly FIG. 3B schematically illustrates similar left-to-right measurements taken at a number of locations on the door 105. In this particular example, the left-to-right distances along the door 105 surface are approximately the same as it would be obtained by directly measuring the image of FIG. 1 since the door is relatively flat along those measurement lines.

FIGS. 4A and 4B contain a schematic representation of how the door 105 of FIG. 3 might appear after “flattening” it according to the instant invention. That is, the horizontal 340-350 measurements and vertical 305-320 measurements have been used to stretch the door 105 so that the proportions are approximately those of the actual surface. Note that in some applications the entire vehicle will be distorted, not just a particular element. That being said, those of ordinary skill in the art will recognize how this approach could be extended to multiple components of the vehicle. Further, it should be noted that the distortion that can be readily observed in the door image 405 of FIG. 4 is probably in excess of what would be observed in practice. The figures used herein have been exaggerated for purposes of illustration.

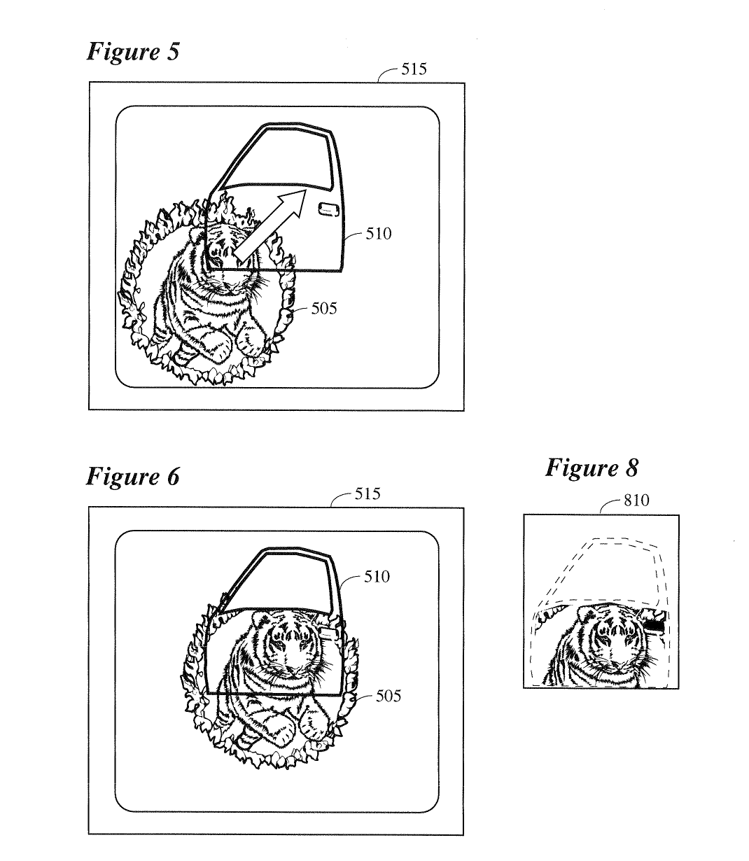

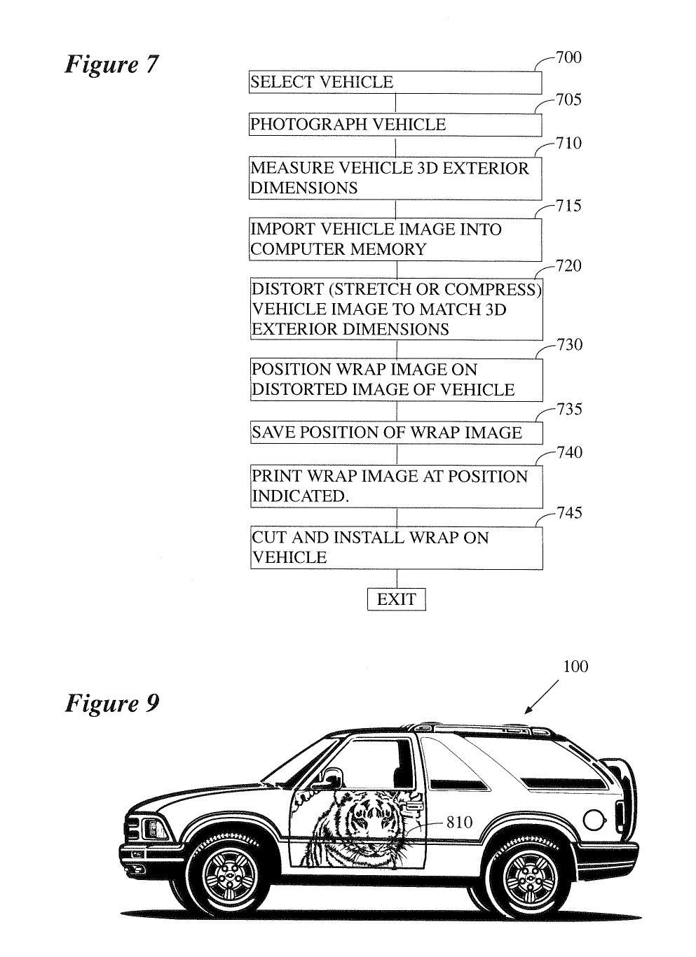

FIG. 5 illustrates how a graphic 505 which is to be applied to a wrap might be maneuvered for fitting when displayed on a computer screen 515 along with a stretched representation 510 of the door 105. In a preferred arrangement, a user will maneuver the graphic 505 until it overlays the distorted door image 510 exactly as it is to appear in the finished wrap.

FIG. 6 illustrates how the computer screen 515 might appear after a user has positioned the graphic 505 on the door image 510 as it is intended to appear on the chosen vehicle 100.

Finally, FIG. 8 illustrates a wrap 810 on which has been positioned and printed a cropped version of the graphic 505. The wrap 810 will then be cut and applied to the car door 105. FIG. 9 illustrates in a general way how the wrap 810 might appear after it has been cut and installed.

Turning now to a more detailed discussion of the instant invention and according to a first preferred step, a vehicle will be selected 700. Obviously, any sort of vehicle (to include sedans, SUVs, pickup trucks, vans, busses, trailers, boats, airplanes, etc.) could potentially be used, with white or other light-colored vehicles being generally preferred because such generally make the wrap more visible.

As a next preferred step 705, the vehicle will preferably be photographed using a digital camera that is 4 megapixels or greater. The camera should be placed on a tripod or otherwise securely supported to make certain that the resulting picture is a sharp as possible. In the preferred arrangement, the camera will be oriented to be as nearly square as possible with respect to the surface of the vehicle that is to be photographed because any slant or skew or misalignment of the camera will cause the resulting photo to be distorted. Preferably, the camera will be situated some distance from the vehicle to reduce distortion as much as possible, with longer distances being advisable in instances where the vehicle is longer.

In some preferred arrangements, the camera will be situated at least 30 feet away from the vehicle in order to prevent distortion (e.g., barrel distortion). In some cases, a greater distance may be necessary. Preferably, the vehicle will occupy about the middle 50% of the digital photo, leaving 25% negative space to the left and right of the vehicle.

When hoods and trunks are photographed, it will usually be necessary to place the camera at an elevated location. In some preferred embodiments, a stepladder will be positioned along the centerline of the vehicle at a distance of about 6 feet from the body. Preferably, the same rules regarding negative space will be observed when positioning the hood or trunk within the camera digital image.

As a next preferred step 710, a seamstress' tape or other flexible tape measure—or any other measurement device (e.g., a measuring wheel) that can measure the actual contours of the horizontal and vertical dimensions of surfaces just photographed—will be used to obtain measurements of the vehicle surface that is to receive the wrap. Preferably, care should be taken to push the tape measure into body folds, recesses, and around all curves to ensure that the measurement accounts for the 3-D curvature of that portion of the vehicle. For purposes of the instant disclosure, such measurements will be referred to as “surface” measurements as they are intended to follow the contours of the surface of the vehicle.

Obviously, as the photos and measurements are taken they should be carefully recorded. Extra attention should be paid to start and stop points in order to get the highest quality scale template. Care that is exercised at this step will help produce an accurate measurement of the total amount of material that will be required to cover this vehicle component. Preferably, the measurements will be taken to an accuracy of about one-eighth of an inch or better.

In the preferred arrangement, a detailed hand-drawn and measured rooftop diagram will be prepared that lists any roof racks, sunroofs, corrugated, panels, antennas, etc.

Obviously, during measurement the user should be consistent. For example, if inside seams are being measured, all panels should be measured inside the seams. Such measurement conventions should be noted on the measurement pages and, additionally, anything other conventions that have been observed during the measurement process should similarly be recorded.

As a next preferred step 715, the digital images of the subject vehicle will be imported into the computer. Of course, and as has been discussed previously, in some instances a stock photo will be used instead of a photo of the actual vehicle in which case the importation step could be accomplished by reading from hard disk or other storage medium.

Next, the measurements taken previously will be used to re-size the photograph or photographs by essentially “flattening” them (step 720). In the preferred embodiment, at least one dimension of the photograph will be resized (typically stretched) with respect to the other so that the resulting image more accurately reflects the actual surface area of the automobile at the target location(s) that is to receive the wrap. For purposes of the instant disclosure, the term “surface area” will be used to refer to the actual surface area of the region to which the wrap is to be applied, taking into account the contours and undulations of the target region. In practical terms, the surface area is the best measure of the amount of wrap media that will actually be required to cover the target portion of the vehicle.

Note that in some instances, both axes may need to be adjusted at one or more measurement points. For example, consider an automobile hood that has an air intake feature (e.g., an hood scoop) that is to be covered by the wrap. In a case such as this, the resulting image would be stretched in both directions in the vicinity of the air intake. Of course, in some cases only one dimension will need to be adjusted.

Preferably some sort of determination will be made as to the relationship between each pixel in an image and the vehicle represented therein. For example, it may be that each pixel in a 4 megapixel image of particular vehicle image might represent a few hundredths of an inch (both in the horizontal and vertical directions) in the real world. In that case, it should be clear how the image might be expanded to match the corresponding surface measurements.

By way of illustration only, suppose that a door panel measured via a 2D projection provided by a properly oriented camera, appears to be 24 inches in height. But, when measured with a flexible measuring tape along its surface, the door panel surface is determined to be, instead, 26 inches high which reflects the fact that the door is outwardly curved for stylistic and/or aerodynamic reasons. According to the instant invention, that component of the car photograph should then be expanded so that the vertical height of the door in pixels as seen through the camera matches its actual measurement length. This will result in some small amount of distortion to the photographed image. However, and as is explained subsequently, this allows the graphic that is intended for use on this vehicle to be more accurately positioned, printed, and cut.

As a next preferred step, the automobile digital image, which has been distorted so that its components indicate the actual surface length of each item on the photograph, will be used in conjunction with a user-selected graphic and/or text image that is to be printed on a wrap for installation on this part of the automobile. See generally FIGS. 5, 6, and 8. The advantage of having previously distorted the image of the vehicle to match its actual vertical and horizontal surface dimensions is that, when a graphic image is positioned over the now-distorted image of the automobile, features of that image can reliably be positioned relative to the automobile features. By way of illustration, if it is important that a word or graphic element appear just below the door handle of the car, the wrap designer would like some assurance that the relative positioning of the graphic on the vehicle as it appears on the computer screen will be replicated on the vehicle when the printed wrap is installed. By using the approach of the instant invention, if a word or graphic element appears on the computer screen below the door handle the user will have some confidence that, when the wrap is actually printed and installed, that after installation that word or graphic element will appear on the vehicle as it appeared on the computer screen.

After the graphic is positioned on top of the distorted image of the vehicle of choice, and the user is satisfied with this selection, as a next preferred step 735, the exact placement of the image will be noted and saved for use during printing.

Next, preferably the graphic image that is to be printed on the wrap, or perhaps a higher resolution version of same, will be sent to a wrap printer (step 740). A wrap printer is designed to print graphics and/or text on very wide pieces of printer media (e.g., two or four mil vinyl film is often used). As is well known to those of ordinary skill in the art, printers of various dimensions are readily available that can print the user's selected graphic on wrap media. For example, printers are commonly available in widths such as 30 inches, 42 inches, 54 inches, and 64 inches which can handle the correspondingly larger media sizes (e.g., 36 inches, 48 inches, 60 inches, and 72 inches, respectively).

After the wrap image has been printed on vinyl or other medium, it can be taken to the subject vehicle and installed (step 745) with confidence that the registration points of the wrap will match the corresponding points on the vehicle.

By way of summary, the instant invention is designed to allow wrap installers to accurately predict where various features of a graphic will appear when printed full size for attachment to an automobile or other vehicle. The preferred way of doing this includes taking photographic images of the subject vehicle (or another vehicle of the same make, model, and year) and then distorting the photographic image of the vehicle to be proportional to the surface measurements taken from the vehicle. The distorted image is then preferably utilized as a background for a user who wishes to apply a graphic to a vehicle. Because the photographed surface of the car has been “flattened” according to the instant invention, the graphical wrap image that is positioned on it will appear on the subject vehicle as it does on the computer screen.

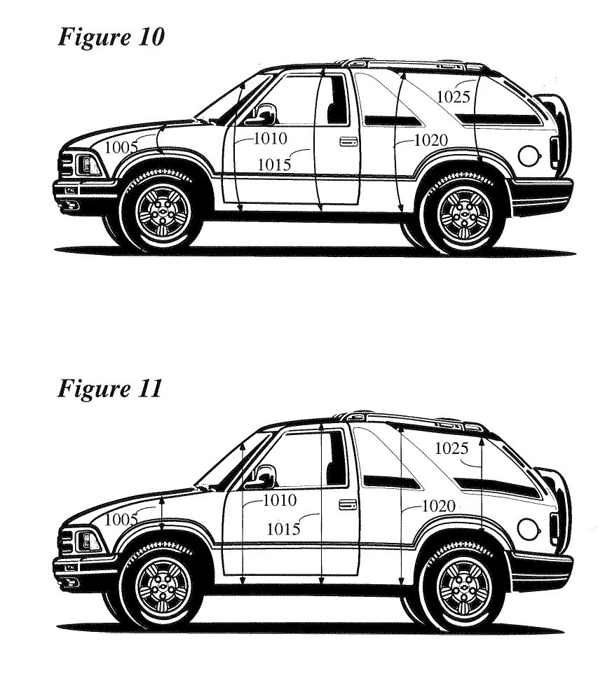

Although the instant invention has been discussed for purposes of illustration only as being applied to a single element of the vehicle (i.e., the door 105) those of ordinary skill in the art will understand that the same procedure could be applied to larger portions (or the entirety) of the vehicle 100. That is, by making multiple measurements 1005-1025 at different points along the exterior of vehicle 100 the image of FIG. 1 could readily be stretched or otherwise distorted as is indicated. See, for example, FIGS. 10 and 11. Note that, as was the case in FIGS. 3A and 3B, curved segments are used to represent surface measurements of the vehicle with the corresponding straight segments representing the actual length of the segment after the underlying image has been distorted according to the instant invention.

Note that although it might appear from the instant figures that only a few vehicle measurements would be required to implement the instant invention, those of ordinary skill in the art will recognize that in practice numerous measurements would be taken to determine, for example, the precise location and dimensions of the windows, the locations of door handles, gas access points, air intakes, headlights, turning lights, etc.

Additionally it should be noted that the instant inventor contemplates that a database might be assembled that contains stock photos of numerous types of vehicles (taken from various angles), perhaps both with and without stretching applied. This database would then be supplied to users upon the payment of a fee of some sort. The advantage to an end user should be clear: in many cases actual vehicle measurements of a subject vehicle would not be necessary. Further, the graphical stretching will have been done would have been performed by professionals, thereby increasing the chances that the resulting wrap would fit properly.

Finally, it should be noted and remembered that although a digital image of the subject vehicle (or another photograph of the same type of vehicle) is the preferred way of presenting a template to the user within a computer, that is not the only way this information might be presented. For example, an accurate line or other drawing might be used instead. However, the preferred image source is a photograph of the subject vehicle.

Thus, the present invention is well adapted to carry out the objects and attain the ends and advantages mentioned above as well as those inherent therein. While presently preferred embodiments have been described for purposes of this disclosure, numerous changes and modifications will be apparent to those in the art. Such changes and modifications are encompassed within the spirit of this invention as defined by the appended claims.

What is claimed is:

1. A method of producing a vehicle wrap for use on a vehicle, comprising the steps of:
(a) selecting a portion of said vehicle suitable for application of said vehicle wrap thereto;
(b) obtaining a digital image representative of said selected portion of said vehicle;
(c) obtaining a plurality of surface measurements representative of said selected portion of said vehicle;
(d) using at least one of said plurality of surface measurements to adjust said digital image along at least one dimension to produce an adjusted digital image, said adjusted digital image being at least approximately proportional in size to a surface area of said selected portion of said vehicle;
(e) selecting a wrap image;
(f) displaying at least a portion of said wrap image and said adjusted digital image together on a display device;
(g) positioning said wrap image on said display device with respect to said adjusted digital image;
(h) determining a relative position of said wrap image and said adjusted digital image after they have been so positioned; and,
(i) using at least said relative position of said wrap image and said adjusted digital image to print at least a portion of said wrap image to a wrap medium, thereby producing said vehicle wrap for use on said vehicle.

2. A method of fitting a vehicle wrap to a vehicle according to claim 1, wherein said digital image representative of said vehicle is a digital photograph of said vehicle.

3. A method of fitting a vehicle wrap to a vehicle according to claim 1, further comprising the step of:
(j) affixing at least a portion of said wrap medium to said vehicle.

4. A method of fitting a vehicle wrap to a vehicle according to claim 1, further comprising the step of:
(j) removably affixing at least a portion of said wrap medium to said vehicle.

5. A method of fitting a vehicle wrap to a vehicle according to claim 1, step (d) comprises the step of:
(d1) using a flexible tape measure to obtain a plurality of surface measurements at least representative of said selected portion of said vehicle.

6. A method of fitting a vehicle wrap to a vehicle according to claim 1, wherein said wrap medium is selected from a group consisting of a vinyl sheet and a plastic sheet.

7. A method of fitting a vehicle wrap to a vehicle according to claim 1, wherein digital image representative of said vehicle is a digital photograph of said vehicle.

8. A method of fitting a vehicle wrap to a vehicle according to claim 1, wherein digital image representative of said vehicle is a digital photograph of a different vehicle, wherein said different vehicle has a same make and a same model type as said vehicle.

9. A method of creating a vehicle wrap, comprising the steps of:
(a) selecting a vehicle;
(b) selecting a portion of said vehicle suitable for applying said vehicle wrap thereto;
(c) obtaining a digital image representative of at least a portion of said vehicle, said digital image including at least said selected portion of said vehicle;
(d) storing said digital image on a computer readable medium;
(e) obtaining a plurality of surface measurements at least representative of said selected portion of said vehicle;
(f) reading said digital image from said computer readable medium into a computer;
(g) using at least one of said plurality of surface measurements to adjust at least one dimension portion of said digital image to produce an adjusted digital image, said adjusted digital image having a surface area proportional to a surface area of said selected portion of said vehicle;
(h) selecting a wrap image;
(i) displaying said adjusted digital image and at least a portion of said wrap image on a display device;
(j) positioning said wrap image on said display device with respect to said adjusted digital image;
(k) determining a relative position of said wrap image and said adjusted digital image after they have been so positioned; and,
(l) using at least said relative position of said wrap image and said adjusted digital image to print at least a portion of said wrap image to a wrap medium, thereby producing said vehicle wrap for use on said vehicle.

10. A method of fitting a vehicle wrap to a vehicle according to claim 9, further comprising the step of:
(m) affixing at least a portion of said wrap medium to said vehicle.

11. A method of fitting a vehicle wrap to a vehicle according to claim 9, further comprising the step of:
(m) removably affixing at least a portion of said wrap medium to said vehicle.

12. A method of fitting a vehicle wrap to a vehicle according to claim 9, step (e) comprises the step of:
(e1) using a flexible tape measure to obtain a plurality of surface measurements at least representative of said selected portion of said vehicle.

13. A method of fitting a vehicle wrap to a vehicle according to claim 9, wherein said wrap medium is selected from a group consisting of a vinyl sheet and a plastic sheet.

14. A method of fitting a vehicle wrap to a vehicle according to claim 9, wherein digital image is a digital photograph of said vehicle.

15. A method of fitting a vehicle wrap to a vehicle according to claim 9, wherein digital image is a digital photograph of a different vehicle, wherein said different vehicle has a same make and a same model type as said vehicle.
